(19) United States
(12) Patent Application Publication
(10) Pub. No.: US 2006/0135234 A1
(43) Pub. Date: Jun. 22, 2006

(54) System and method for automatically enabling and disabling advertising in video games

(76) Inventors: Dhananjay Godse, Kanata (CA); Daniel Willis, Stittsville (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,974

(22) Filed: Dec. 19, 2005

Related U.S. Application Data
(60) Provisional application No. 60/636,541, filed on Dec. 17, 2004.

(51) Int. Cl. A63F 13/00

(52) U.S. Cl. 463/1

(57) ABSTRACT

A method for automatically enabling and disabling advertising in an advertising enabled gaming environment includes providing a video game in execution on a gaming platform having communications with a communications network. In addition, a server is provided within the communications network for delivering of advertising content to the video game. To this end, the advertising content is retrievably stored in at least a storage location for access by the server. According to a set of rules, delivery of the advertising content to the video game is selectively disabled. Such disabling is performed absent disabling of a network connection between the gaming platform and the server and absent deleting of the advertising content from the at least a storage location.

### REFERENCE TO PRIOR APPLICATION

This application claims benefit from U.S. Provisional application 60/636,541 filed on Dec. 17, 2004, the entire contents of which is incorporated herein by reference.

### FIELD OF THE INVENTION

The instant invention relates generally to advertising on the Internet, and more particularly to a system and a method combining computer gaming with Internet advertising.

### BACKGROUND OF THE INVENTION

During recent years, computer gaming has gained increasing popularity, and today thousands of players are playing games all around the world. Predictably, interactive computer gaming has blurred the line between games and other entertainment or communication media, and the avenues that are being explored in the development of gaming might well break new ground for interactive Internet applications in all areas of business relations and social life.

Due to their dynamic nature and specific appeal to certain audiences, computer games and especially games played on Internet enabled platforms provide the ideal vehicle for Internet advertising. Not only is it possible for an advertiser to target directly a specific group of customers, but also advertisements can be directly incorporated into the computer games, enabling something akin to the well-known concept of product placement. In such a system, a game is running on a system that is connected to the Internet. Throughout the playing of the game, the game software contacts a set of ad servers to retrieve advertising content to present to the user during game play. The data and advertising content is transferred using HTTP protocols over the Internet. Optionally, the advertising content is cached locally to the game, and throughout the playing of the game the game software contacts a set of ad servers to retrieve a list of advertising content to present to the user during game play.

The scheduling of advertising content delivery to a particular game is controlled by an ad service that runs the ad servers. In turn, the ad service is influenced by the game producers and by the advertisers that provide the advertising content, as well as by the game console providers. In such a system, the advertisers have a rough knowledge of how many games have been sold and roughly where they have been sold.

It would be advantageous to provide a method and system for suspending delivery of a subset of advertising content to a population of games in execution on online enabled platforms. For example, it would be advantageous to allow the operator of an ad server to terminate the delivery of ads from a specific advertiser due to non-payment for services rendered, etc. Similarly, it would be advantageous in an environment including an advertising broker site, as described for instance in U.S. Provisional Patent Application 60/636,541, filed on Dec. 17, 2004 and in a co-pending U.S. patent application claiming priority therefrom and filed on Dec. 19, 2005, the entire contents of both of which are incorporated herein by reference, to allow the advertising broker site to terminate ad delivery to all games from a particular ad server for the reason of overdue payments, etc. In addition, it would be advantageous to allow the inventory broker site or another entity to terminate all or some advertising to particular geographic locations or during particular periods of time. Furthermore, it would be advantageous to allow a particular game or hardware platform to turn off all advertising content delivery to that game or hardware platform, based upon client-side constraints imposed by an individual gamer, hardware manufacturer, or regulating body.

### SUMMARY OF EMBODIMENTS OF THE INVENTION

In accordance with an aspect of the instant invention there is provided a method for automatically enabling and disabling advertising in an advertising enabled gaming environment in execution on an online enabled platform, the environment including a gaming portion for supporting game play and for displaying advertising content during game play, and an advertisement-providing portion that is in communication with the gaming portion via a communications network, the method comprising: associating a plurality of different pieces of advertising content with the advertisement-providing portion; defining a characteristic for each one of the plurality of different pieces of advertising content; retrievably storing said characteristic for access within the advertisement-providing portion; and, disabling delivery to the gaming portion for a known piece of advertising content selected from the plurality of different pieces of advertising content based on a current value of the characteristic for the known piece of advertising content.

In accordance with another aspect of the instant invention there is provided a method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising: providing a piece of advertising content for being displayed by the gaming portion during game play, the piece of advertising content associated with an entity of the advertisement-providing portion; determining a current status of the entity of the advertisement-providing portion; and, when the current status of the entity of the advertisement-providing portion is indicative of an enabled content delivery state, making the piece of advertising content available for display by the gaming portion.

In accordance with another aspect of the instant invention there is provided a method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising: retrievably storing first data relating to an inventory of advertising content, the first data including entries for specific pieces of advertising content and accessible within the advertisement-providing portion; retrievably storing second data relating to a rule for excluding a specific piece of advertising content from a list of advertising content that is available for display by the gaming portion, the second data accessible within the advertisement-providing portion; receiving a request at the advertisement-providing portion for an indication of advertising content that is available for display by the gaming portion; and, accessing the stored second data, for applying the rule to determine an indication of advertising content that is available for display by the gaming portion, the indication excluding the specific piece of advertising content the rule is satisfied.

In accordance with another aspect of the instant invention there is provided a method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising: providing a piece of advertising content for being displayed by the gaming portion during game play, the piece of advertising content associated with a first entity of the advertisement-providing portion; retrievably storing data for being accessed by a second entity of the advertisement-providing portion, the data relating to a current status of the first entity; receiving a request at the second entity for pieces of advertising content that are available for display by the gaming portion; accessing the stored data at the second entity; determining a current status of the first entity based on the accessed stored data; and, excluding the piece of advertising content from a list of pieces of advertising content that are available for display by the gaming portion, in dependence upon the determining that the current status of the first entity is not-enabled for delivery of advertising content associated therewith.

In accordance with another aspect of the instant invention there is provided a method comprising: providing a video game in execution on a gaming platform having communications with a communications network; providing a server within the communications network for delivering of advertising content to the video game, the advertising content retrievably stored in at least a storage location for access by the server; and, selectively disabling delivery of the advertising content to the video game, absent disabling of a network connection between the gaming platform and the server and absent deleting of the advertising content from the at least a storage location.

In accordance with another aspect of the instant invention there is provided a method comprising: providing a video game in execution on a gaming platform having communications with a communications network; providing a server within the communications network for delivering of advertising content to the video game, the advertising content retrievably stored in at least a storage location for access by the server; and, selectively enabling delivery of the advertising content to the video game, the advertising content being by default disabled for delivery to the video game.

In accordance with an aspect of the instant invention there is provided a set of ad servers for storing and delivering advertising content and policy data to a game in execution on an online enabled platform for presentation to a game player. The ad servers are connected to the Internet, as are the computers and consoles that host the games. Optionally, an inventory broker site is provided for returning the address of the ad server based on the game title and the place in game where the ad will be presented, which is referred to as a spot identifier.

In accordance with another aspect of the instant invention there is provided a method for mapping the Internet protocol address (IP Address) of a computer to the geographic location (geolocation) of that computer. These mappings are built by various companies that scan public databases of IP address owners and package the data as geolocation lookup tables for use by online services. The geolocation coordinates are detailed enough to give advertisers a precise geographic target, but coarse enough to give gamers anonymity; i.e. pinpoints the gamer down to a region or a city.

In accordance with another aspect of the instant invention, there is provided a method to uniquely identify the title of a game in play. This is provided to the game publisher by the provider of access to the advertising system, either an advertising service provider (ADSP) or an advertising broker site, and is embedded inside the game for use as a key to get advertising content appropriate to the game.

In accordance with an aspect of the instant invention, provided is a system and method for suspending advertising from a particular advertising agency, or from a particular advertiser, or from a particular ad server, or to a particular game title, or to a particular geographic location.

### BRIEF DESCRIPTION OF THE DRAWINGS

Embodiments of the instant invention will now be described in conjunction with the following drawings, in which

FIG. 1 is a schematic block diagram showing a broker mediated on-line advertisable gaming environment;

FIG. 2 is a schematic block diagram showing a particular mode of communication for the system of FIG. 1;

FIG. 3 shows a CurrentActivityTable of the type that is maintained by one of and ad server and an advertising broker site according to an embodiment of the instant invention;

FIG. 4 shows a CurrentAdTable of the type that is maintained by one of an ad server and an advertising broker site according to an embodiment of the instant invention;

FIG. 5a shows a CurrentAdServerTable of the type that is maintained by an advertising broker site according to an embodiment of the instant invention;

FIG. 5b shows an AllGameTitlesTable of the type that is maintained by one of an ad server and an advertising broker site according to an embodiment of the instant invention;

FIG. 6a shows an All Advertisers table of the type that is maintained by one of an advertising broker site and an ad server according to an embodiment of the instant invention;

FIG. 6b shows an All Geographic Locations table of the type that is maintained by one of an advertising broker site and an ad server according to an embodiment of the instant invention;

FIG. 6c shows an All Ad Agencies table of the type that is maintained by one of an advertising broker site and an ad server according to an embodiment of the instant invention;

FIG. 7 is a simplified flow diagram of a method according to an embodiment of the instant invention;

FIG. 8 is a simplified flow diagram of another method according to an embodiment of the instant invention;

FIG. 9 is a simplified flow diagram of yet another method according to an embodiment of the instant invention;

FIG. 10 is a simplified flow diagram of still another method according to an embodiment of the instant invention;

FIG. 11 is a simplified flow diagram of still another method according to an embodiment of the instant invention; and,

FIG. 12 is a simplified flow diagram of still another method according to an embodiment of the instant invention.

### DETAILED DESCRIPTION OF THE INVENTION

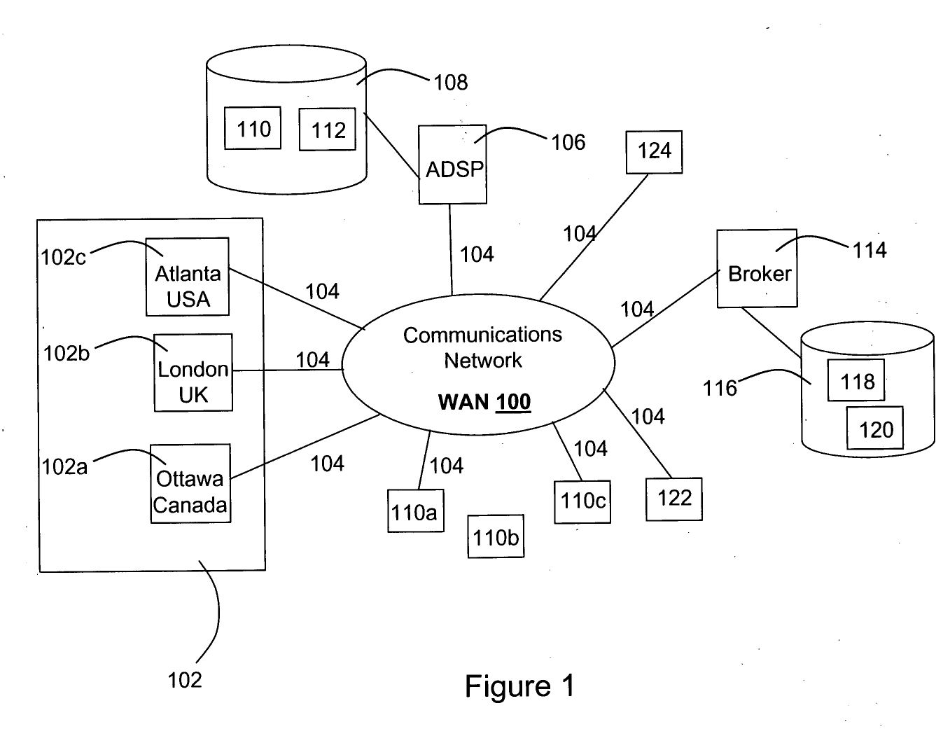

Referring now to FIG. 1, shown is a high-level block diagram of a broker mediated advertisable gaming environment. Game 102 is connected to a communications network 100 via connections 104. The communications network 100 is an Internet protocol (IP) network, which optionally comprises an access aggregation network (AAN). The AAN generally is a wide area network (WAN), and preferably is a broadband access network (BAN). The geographic location (geolocation) of each game site 102a-c is known, for instance game site 102a is located at Ottawa, Canada, game site 102b is located at London, UK, and game site 102c is located at Atlanta, USA. A single game site is primarily characterized as being part of game 102, yet since advertisements are displayed within devices located at the single game site, such a site also exhibits certain “advertising site” characteristics. Optionally, the geolocation of the game sites is determined using an available geolocation service provider. Further optionally, geolocation information is provided by a gamer at a game site. Further alternatively, the geolocation is determined using another method.

A user located at one of the game sites 102a, 102b or 102c purchases game software, and connects to the communications network 100 to play the game with likeminded individuals. Optionally, the user plays the game on their own, but the game platform still connects to the communications network 100 at least some of the time. As will be apparent to one of skill in the art, the game software is loaded onto a computer system that is located at the one of the game sites 102a, 102b or 102c. The game software is optionally loaded from a storage medium such as a compact disc, or it is loaded over the communications network 100. The game software includes a unique game identifier for the game title, the unique game identifier being embedded in the game software at the time the game software is built.

An advertising service provider (ADSP) site 106 also is connected to communications network 100 via a connection 104. ADSP 106 implements one or more ad campaigns at a time. To this end, ADSP 106 includes an ad server for delivering content 110 that is provided by different advertisers 110a-c, to a limited number of available spots within instances of game 102. A catalog of content 110 that is provided by advertisers 110a-c is stored in storage portion 108. This catalog includes predefined target characteristics and advertisement data for individual ads and for ad campaigns. Additional data 112 also is stored in the storage portion 108.

Referring still to FIG. 1, ADSP 106 “buys” up blocks of spots within game 102 and then “re-sells” these spots to advertisers 110a-c for displaying advertising content over a period of time. The process of managing and scheduling advertising content delivery includes selecting appropriate advertising content from a plurality of different advertising campaigns, for delivery to a plurality of instances of game 102. Providing an advertising broker site 114, which is connected to communications network 100 via a connection 104, facilitates efficient execution of these processes. The advertising broker site 114 constitutes a bridge between ADSP 106 and game 102. Accordingly, the advertising broker site 114 includes a storage portion 116 for storing an inventory 118 containing characteristic information for registered games and business logic that integrates the game 102 and the ADSP 106, as well as for storing other data 120. For each registered game, there exists a unique inventory entry. If there is no characteristic information available for a registered game, then the entry in the inventory 118 is referred to as null entry.

ADSP 106 licenses games from the advertising broker site 114, such that any request to the advertising broker site 114 for advertising content that is associated with ADSP 106 is directed appropriately to ADSP 106. Based on the entry of a registered game in the inventory 118, the ADSP 106 serves certain advertisements for being displayed at particular spots of game 102. In this way, the characteristic inventory entry of a registered game and predefined target characteristics of an advertisement out of the catalog of advertisements are used to perform mapping between possible enabled spots and advertisements for display within those spots.

In FIG. 1, advertisers 110a and 110c are connected to communications network 100 via a connection 104, but advertiser 110b is not. Any of the advertisers 110a-c optionally provides content directly to ADSP 106 via the communications network 100 if available, or via a portable storage medium such as a CD or a DVD. Optionally, the advertisers 110a-c utilize the services of an ad agency 122, which is connected to the communications network 100 via a connection 104. The ad agency 122 acts as an intermediary between the advertisers 100a-c and ADSP 106. Optionally, at least one game console provider 124 is connected to the communications network 100 via a connection 104.

Of course, the example that is shown in FIG. 1 represents a relatively simple system, which is presented in order to facilitate an understanding of the basic principle underlying embodiments of the instant invention. In practice, a plurality of ADSPs each implementing a plurality of advertising campaigns is connected to the communications network 100, rather than just one ADSP as is shown in this simplified example. Furthermore, advertising content is optionally scheduled for delivery to a plurality of different games, rather than to just one game as is shown in the simplified example. Clearly, the role of the advertising broker site 114 becomes more important as the complexity of the system increases. However, the same principles that are applied in this relatively simple, and non-limiting, example are also applied in more complex systems.

Additionally, storage portion 108 is shown in FIG. 1 as a unitary storage unit, but optionally includes any number of independent or inter-related storage elements, including but not limited to local hard disk drives, network drives, storage tapes, and other storage elements that are located either local to or remote from ADSP 106. Similarly, storage portion 116 is shown in FIG. 1 as a unitary storage unit, but optionally includes any number of independent or inter-related storage elements, including but not limited to local hard disk drives, network drives, storage tapes, and other storage elements that are located either local to or remote from advertising broker site 114. Furthermore, the connections 104 that are shown in FIG. 1 optionally include physical connections or wireless connections, such as a satellite communication channel, a radio-frequency connection or a free-space optical connection, and various combinations of physical and wireless connections are envisaged.

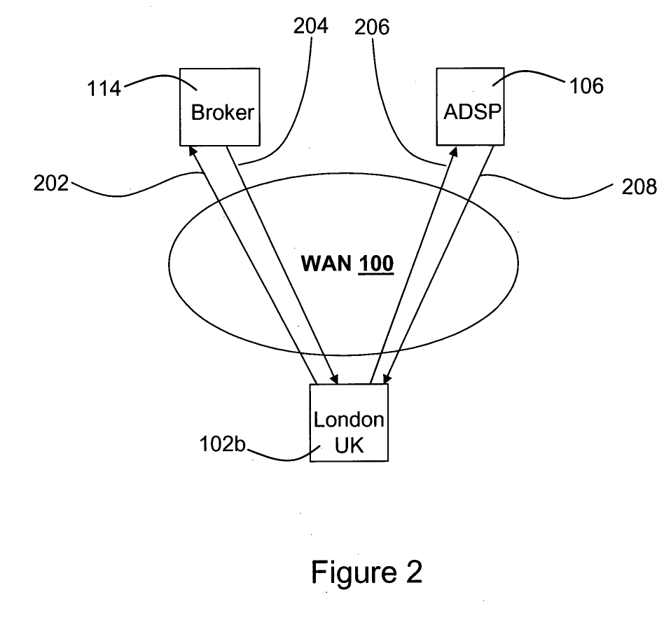

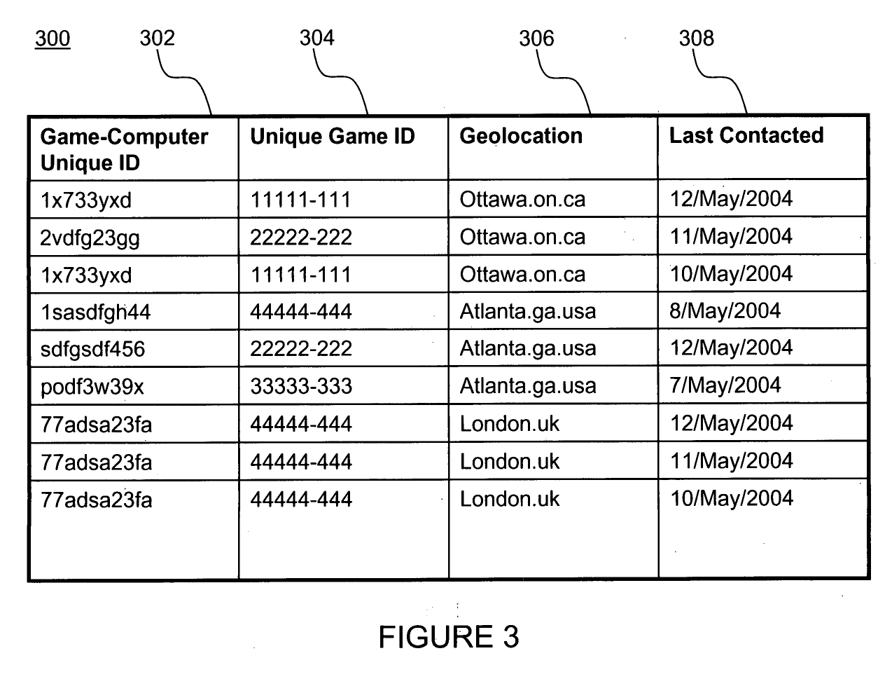

Referring now to FIG. 2, shown is one mode of communication between a specific game site 102b, ADSP 106, and advertising broker site 114. The game software sends a message 202 to advertising broker site 114 requesting the address of an ad server for advertising. Included in message 202, the game software sends the unique game identifier, which was embedded in the game software at the time the game software is developed. When the initial message 202 is received, the advertising broker site 114 obtains the IP address of the sender and uses a geolocation service, which maps the obtained IP address to a geographic location, so as to determine geolocation data relevant to game site 102b. The advertising broker site 114 also extracts from the initial message 202 the unique game identifier as well as a unique identifier, the unique identifier being a combination of a computer identifier and the unique game identifier. The extracted game-computer unique identifier and unique game identifier are entered into a table of a database as shown in FIG. 3, which is referred to as CurrentActivityTable 300. For instance, the extracted game-computer unique identifier and unique game identifier are entered into columns 302 and 304, respectively. Geolocation data and last contact data are stored, for instance in columns 406 and 308, respectively.

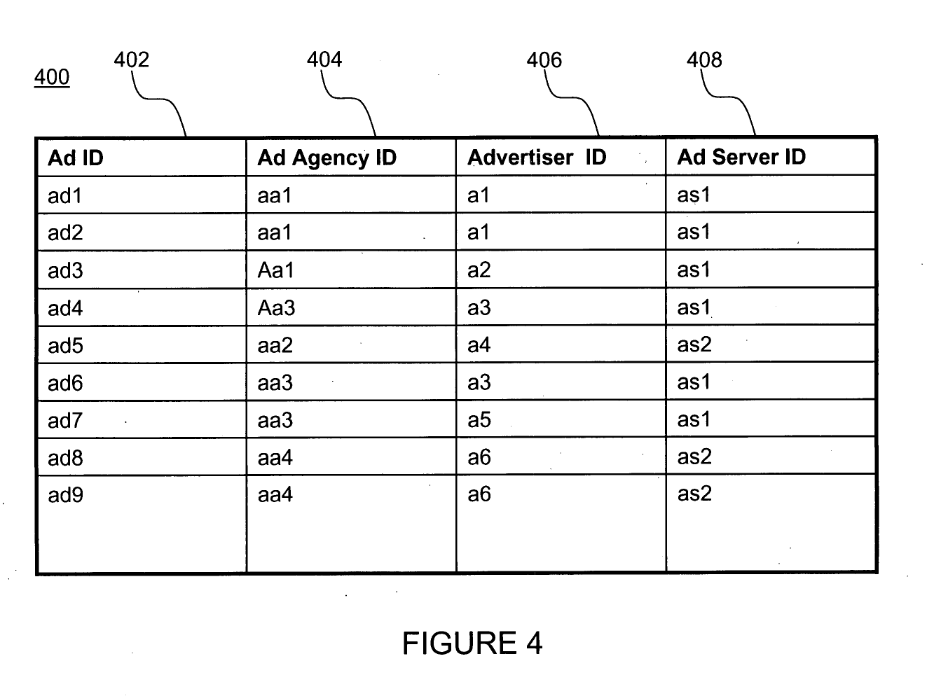

The advertising broker site 114 responds in message 204 by sending a message via communication network 100, the message containing the addresses of ad servers for sourcing advertising content for each subset of spots in game 102. For instance, the advertising broker site 114 maintains a CurrentAdTable 400, as is shown in FIG. 4. The CurrentAdTable 400 correlates specific pieces of advertising content ad1-ad9, which is contained in column 402 in FIG. 4, with a specific advertising agency identifier, a specific advertiser identifier, and a specific ad server (ADSP) identifier, etc. Thus, advertising broker site 114 uses CurrentAdTable 400 to determine that “ad3” is a piece of advertising content provided by ad server “as1” (for instance an ad server of ADSP 106), the content prepared for presentation by ad agency “aa1,” and the content belonging ultimately to advertiser “a2.”

In dependence upon receiving message 204 from the advertising broker site 114, game 102 sends a message 206 to ADSP 106, requesting advertising content availability information for each subset of spots. ADSP 106 sends a message 208 back to game 102, optionally providing actual advertising content or simply a list of available advertising content selected from advertising content that is cached locally to game 102. Based on the advertising content availability information received from ADSP 106, game 102 populates at least a spot as it is displayed using advertising content that is available for display.

In an optional implementation of the above-mentioned system, the functionality of advertising broker site 114 and of ADSP 106 is implemented in one server, such that a combined message including some of the content of messages 202 and 206 is provided in an initial transmission, and the response message 204 is obviated.

The methods and systems that are discussed hereinabove with reference to FIGS. 1-3 support efficient delivery of advertising content for display within a video game in execution on an online enabled platform. Described now is a rules-based approach for supporting enhanced content delivery control, whereby an entity in the advertising value chain specifies conditions for not providing advertising content. In a first broad statement of the rules-based approach, different entities in the advertising value chain are assigned one of an enabled and a not-enabled status. The status of each entity is updated and changed when a specified condition exists. For instance, advertising broker site 114 changes the status of an ad server (ADSP) from enabled to not-enabled as a result of the ad server's failure to pay for services. For instance, any one of advertising broker site 114, ADSP 106, game console provider 124, etc. changes an advertiser's status from enabled to not-enabled for failure to comply with agreed upon standards for content. Optionally, a similar status is assigned to individual pieces of advertising content, or to groups of individual pieces of advertising content. For instance, ADSP 106 changes the status of a piece of advertising content from enabled to not-enabled for a subset of geolocations, because that piece of content is not approved for display during current local times of the subset of geolocations. Alternatively, game console provider 124 immediately changes the status of their game consoles from enabled to disabled upon becoming aware that ads containing inappropriate content are being provided for display using their game consoles. Further alternatively, an ADSP or advertising broker site changes the status of a piece of advertising content from enabled to not-enabled for a subset of geolocations, because that piece of content includes intellectual property that is owned by another within the subset of geolocations. Optionally, the rules are combined and preferably any instance of a “not-enabled” results in no delivery of a piece of advertising content.

In a particular implementation, an interface is provided for allowing authorized entities of the advertising value chain to change the status for various entries of the interface. Different entities are granted different levels of authorization. For instance, the advertising broker site 114, which optionally maintains the interface, is authorized to change the status of any ADSP, any ad agency, any advertiser, any geolocation, any unique game, etc. A particular ADSP is authorized only to change the status of an advertiser or ad agency that provides content to that ADSP. Of course, the ADSP also is permitted to change the status of individual pieces of content associated with such an advertiser or ad agency.

### EXAMPLES

Several specific and non-limiting examples are provided, in order to describe and particularly point out features of embodiments of the instant invention. The examples that follow are not intended to comprise an exhaustive list of examples, and one skilled in the art will recognize other specific implementations and applications of the embodiments of the instant invention.

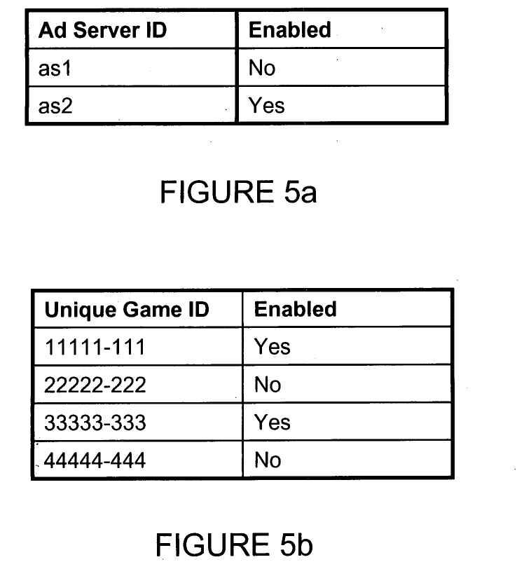

Example 1: a game console sends a request to the advertising broker site 114. The advertising broker site 114 determines the game title based on the unique game identifier included in the request, and determines which ad servers are to send content to that game. If, as in FIG. 5a (CurrentAdServerTable), an ad server (as1) is not enabled, then the address of ad server as1 is not sent to the game console for the purpose of determining from which ad server to fetch content. Thus the broker suspends ad delivery by an ad server by disabling the ad server by writing “No” in the “Enabled” field of the CurrentAdServerTable view. In other words, there is an “Off Button” for ad servers accessible at the advertising broker site 114.

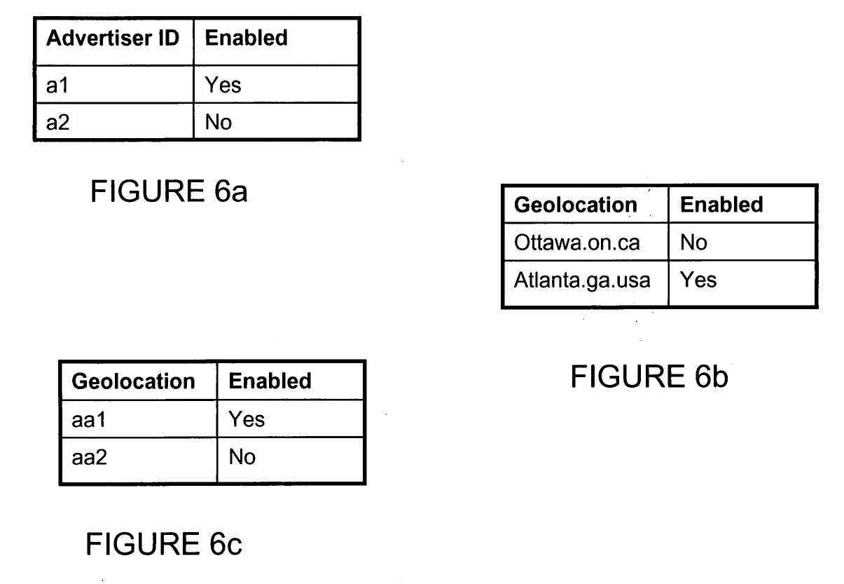

Example 2: a game console contacts an ad server (ADSP) for ads. The ad server, assuming it is enabled by advertising broker site 114, determines a geographic location of the game console. If the determined location is disabled, then ads are not served. If the determined location is enabled, then ads are served. For example, in FIG. 6b, in the table All Geographic Locations, if a request comes from Ottawa.on.ca, then ads are not served, but if a request comes in from Atlanta.ga.usa, then ads are served. Thus the ad server (ADSP) suspends ad delivery to a geographic location by disabling an ad server by writing “No” in the “Enabled” field of the All Geographic Locations view. In other words, there is an “Off Button” for geographic locations at the ad server (ADSP). Optionally, the “Off Button” for geographic locations is at the advertising broker site 114 and/or the ad server (ADSP). Advantageously, this allows the advertising broker site 114 and/or the ad server (ADSP) to implement several different advertising content for a same advertising spot within a same video game and to geographically distinguish each advertising content using the “Off Button” for geographic locations in an associated record within the advertising content database allowing for some advertising content to have different geographic distribution than others. Of course, this is equally applicable to the other selective embodiments described herein by way of example.

Example 3: a game console contacts an ad server (ADSP) for ads. The ad server, assuming it is enabled by advertising broker site 114, determines ads eligible for distribution. If the advertiser that provided an eligible ad is not enabled, then that ad is not served. If the advertiser is enabled, then ads from that advertiser are served. For example, in FIG. 6a, in the table All Advertisers, if an ad is scheduled from advertiser a2, then ads are not served, but if an ad is scheduled from advertiser a1, then ads are served. Thus the ad server suspends ad delivery from an advertiser by disabling an ad server by writing “No” in the “Enabled” field of the All Advertisers view. In other words, there is an “Off Button” for advertisers at the ad server (ADSP). Optionally, the “Off Button” is at the advertising broker site 114 and/or the ad server (ADSP). Advantageously, this allows suspension of ad delivery for advertisers who are other than paying for their advertising campaigns or for other reasons.

Example 4: a game console contacts an ad server (ADSP) for ads. The ad server looks up ads eligible for distribution. If an ad agency associated with an eligible ad is not enabled, then that eligible ad is not served. If the ad agency is enabled then ads are served. For example, in FIG. 6c, in the table All Ad Agencies, if an ad from aa2 is scheduled, then ads are not served, but if an ad from aa1 is scheduled, then ads are served. Thus the ad server suspends ad delivery from and ad agency by disabling an ad agency by writing “No” in the “Enabled” field of the All Ad Agencies view. In other words, there is an “Off Button” for ad agencies at the ad server (ADSP). Optionally, the “Off Button” is at the advertising broker site 114 and/or the ad server (ADSP).

Example 5: a game console sends a request for ads to an ad server (ADSP). The ad server determines the game title based on the unique game identifier included in the request. If the game title is not enabled then ads to this game are not served. If the game title is enabled then ads are served to the game. For example, in FIG. 5b, in the table AllGameTitles, if an ad is scheduled from 22222-222, then ads are not served, but if a request comes in from 11111-111, then ads are served. Thus the ad server suspends ad delivery to a game title by disabling an ad server by writing “No” in the “Enabled” field of the AllGameTitles view. In other words, there is an “Off Button” for games at the ad server (ADSP). Optionally, the “Off Button” is at the advertising broker site 114 and/or the ad server (ADSP).

Further examples include enabling/disabling advertising content based on game developer, game publisher, time of day, geographic data and time of day, internet service provider, and gaming platform identifier.

In all these cases, the various logical views used to enable and disable ad delivery are not necessarily the physical structure of the data. One skilled in the art can translate the views into any physical structure of their choice using methods such as SQL views, or database triggers.

These enabling and disabling criteria or rules are determined at provisioning time by structuring the data so as not to put the disabled entities in the lookup tables. Alternatively, they are established by executing a configured predicate clause that causes the enabling/disabling policy to be executed at runtime on every request. One skilled in the art can configure and execute such a predicate, for example by using SQL, or Pert, or Scheme to describe such a predicate clause. Further alternatively, they are established at another time and/or in another fashion.

Of course, in any system in which advertising content is cached locally to the video game, and content is displayed to a gamer according to a list of available content, then preferably a message is sent to the video game when one or more of the entities in the advertising value chain is assigned a not-enabled status, so as to prevent the video game from displaying “stale” advertising content.

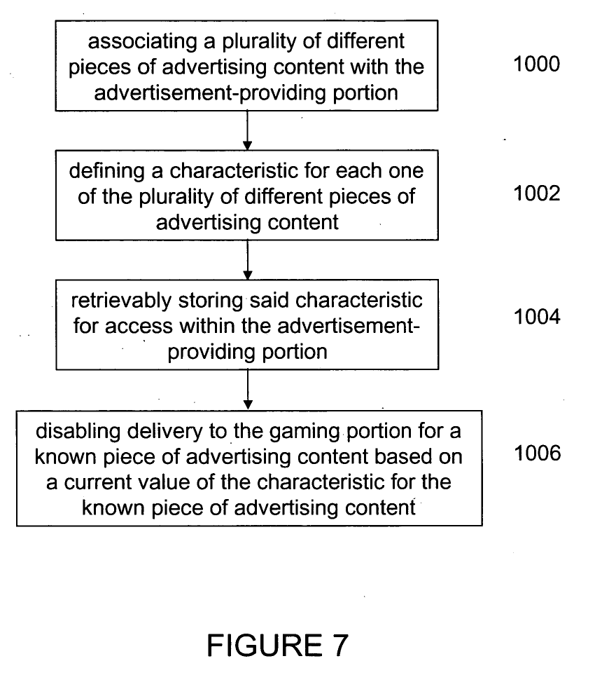

Referring now to FIG. 7, shown is a simplified flow diagram of a method according to an embodiment of the instant invention, for automatically enabling and disabling advertising in an advertising enabled gaming environment in execution on an online enabled platform. In particular, the environment includes a gaming portion for supporting game play and for displaying advertising content during game play, and an advertisement-providing portion that is in communication with the gaming portion via a communications network. At step 1000 a plurality of different pieces of advertising content is associated with the advertisement-providing portion. At step 1002 a characteristic is defined for each one of the plurality of different pieces of advertising content. At step 1004 said characteristic is retrievably stored for access within the advertisement-providing portion. At step 1006 delivery to the gaming portion is disabled for a known piece of advertising content selected from the plurality of different pieces of advertising content, based on a current value of the characteristic for the known piece of advertising content.

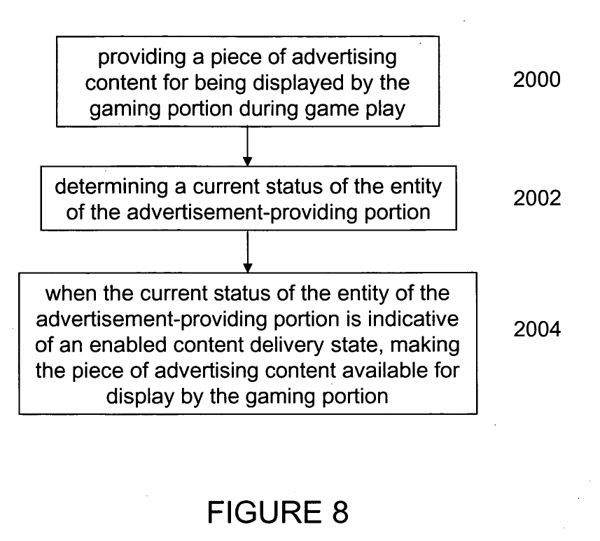

Referring now to FIG. 8, shown is a simplified flow diagram of a method according to an embodiment of the instant invention, for automatically enabling and disabling advertising in an advertising enabled gaming environment in execution on an online enabled platform. In particular, the environment includes a gaming portion for supporting game play and for displaying advertising content during game play, and an advertisement-providing portion that is in communication with the gaming portion via a communications network. At step 2000 a piece of advertising content is provided for being displayed by the gaming portion during game play, the piece of advertising content associated with an entity of the advertisement-providing portion. At step 2002 a current status of the entity of the advertisement-providing portion is determined. At step 2006 when the current status of the entity of the advertisement-providing portion is indicative of an enabled content delivery state, making the piece of advertising content available for display by the gaming portion.

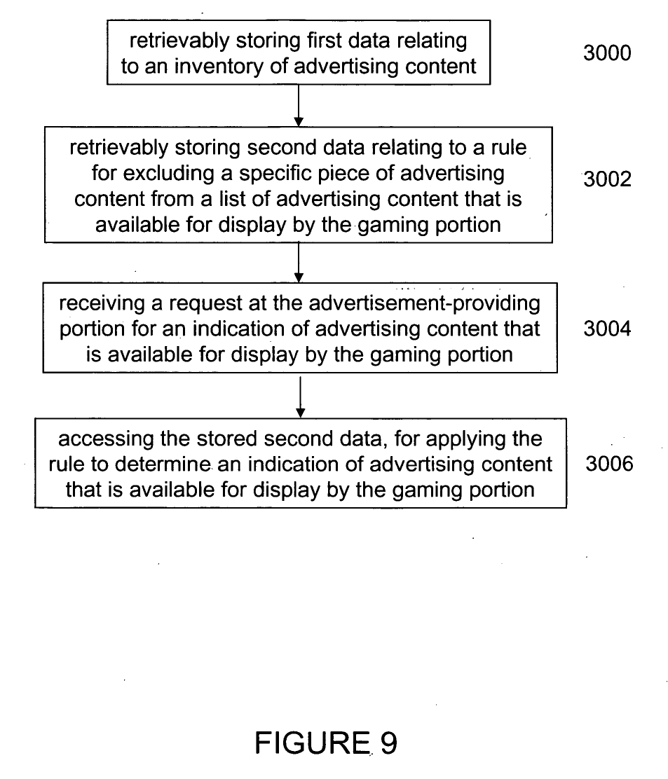

Referring now to FIG. 9, shown is a simplified flow diagram of a method according to an embodiment of the instant invention, for automatically enabling and disabling advertising in an advertising enabled gaming environment in execution on an online enabled platform. In particular, the environment includes a gaming portion for supporting game play and for displaying advertising content during game play, and an advertisement-providing portion that is, in communication with the gaming portion via a communications network. At step 3000 first data relating to an inventory of advertising content is retrievably stored, the first data including entries for specific pieces of advertising content and accessible within the advertisement-providing portion. At step 3002 second data is retrievably stored, the second data relating to a rule for excluding a specific piece of advertising content from a list of advertising content that is available for display by the gaming portion, the second data accessible within the advertisement-providing portion. At step 3004 a request is received at the advertisement-providing portion for an indication of advertising content that is available for display by the gaming portion. At step 3006 the stored second data is accessed, for applying the rule to determine an indication of advertising content that is available for display by the gaming portion, the indication excluding the specific piece of advertising content the rule is satisfied.

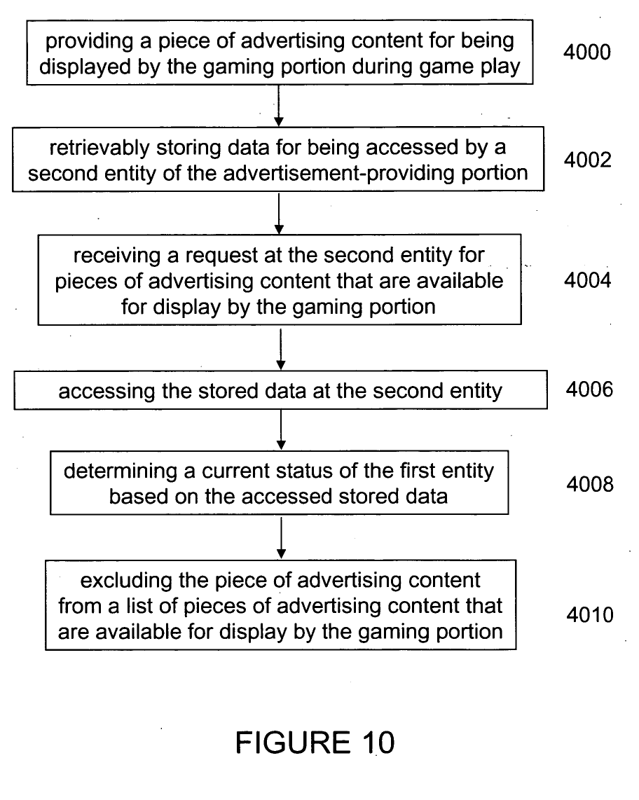

Referring now to FIG. 10, shown is a simplified flow diagram of a method according to an embodiment of the instant invention, for automatically enabling and disabling advertising in an advertising enabled gaming environment in execution on an online enabled platform. In particular, the environment includes a gaming portion for supporting game play and for displaying advertising content during game play, and an advertisement-providing portion that is in communication with the gaming portion via a communications network. At step 4000 a piece of advertising content is provided for being displayed by the gaming portion during game play, the piece of advertising content associated with a first entity of the advertisement-providing portion. At step 4002 data is retrievably stored for being accessed by a second entity of the advertisement-providing portion, the data relating to a current status of the first entity. At step 4004 a request is received at the second entity for pieces of advertising content that are available for display by the gaming portion. At step 4006 the stored data is accessed at the second entity. At step 4008 a current status of the first entity is determined, based on the accessed stored data. At step 4010 the piece of advertising content is excluded from a list of pieces of advertising content that are available for display by the gaming portion, in dependence upon determining that the current status of the first entity is not-enabled for delivery of advertising content associated therewith.

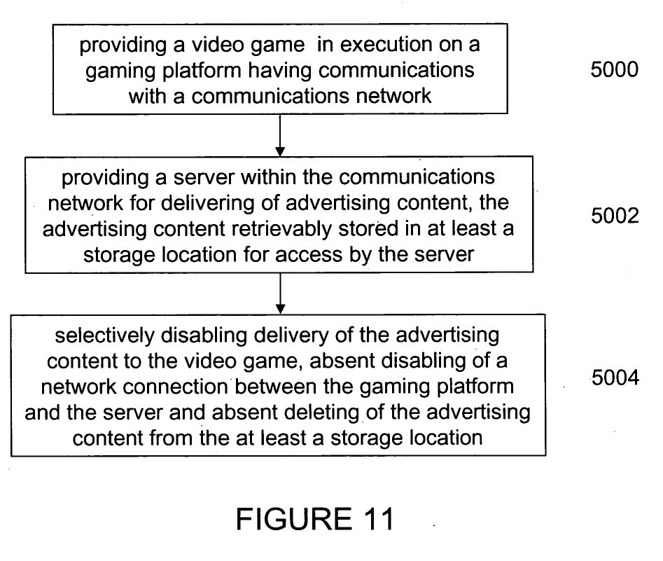

Referring now to FIG. 11, shown is a simplified flow diagram of a method according to an embodiment of the instant invention. At step 5000 a video game is provided in execution on a gaming platform having communications with a communications network. At step 5002 a server is provided within the communications network for delivering of advertising content to the video game, the advertising content retrievably stored in at least a storage location for access by the server. At step 5004 delivery of the advertising content to the video game is selectively disabled, absent disabling of a network connection between the gaming platform and the server and absent deleting of the advertising content from the at least a storage location.

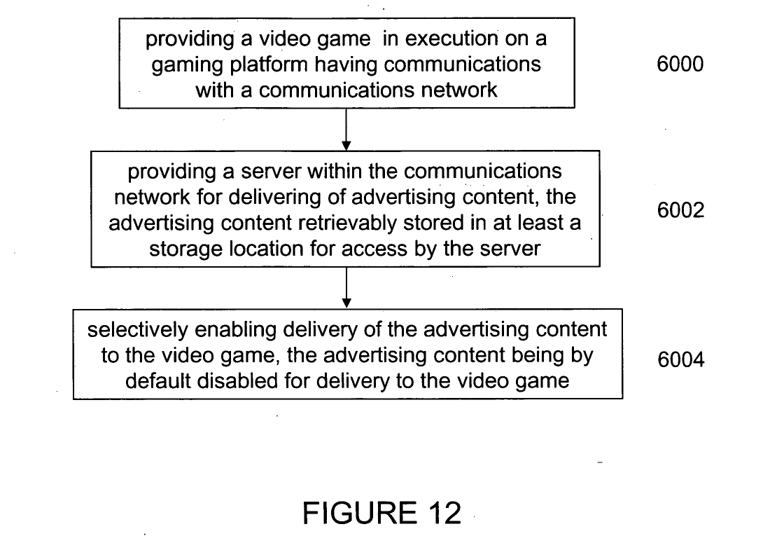

Referring now to FIG. 12, shown is a simplified flow diagram of a method according to an embodiment of the instant invention. At step 6000 a video game is provided in execution on a gaming platform having communications with a communications network. At step 6002 a server is provided within the communications network for delivering of advertising content to the video game, the advertising content retrievably stored in at least a storage location for access by the server. At step 6004 delivery of the advertising content to the video game is selectively enabled, the advertising content being by default disabled for delivery to the video game

Numerous other embodiments may be envisaged without departing from the spirit and scope of the instant invention. All specific examples have been provided for illustrative purposes only and are not intended to be limiting in any way.

What is claimed is:

1. A method for automatically enabling and disabling advertising in an advertising enabled gaming environment in execution on an online enabled platform, the environment including a gaming portion for supporting game play and for displaying advertising content during game play, and an advertisement-providing portion that is in communication with the gaming portion via a communications network, the method comprising:
associating a plurality of different pieces of advertising content with the advertisement-providing portion;
defining a characteristic for each one of the plurality of different pieces of advertising content;
retrievably storing said characteristic for access within the advertisement-providing portion; and,
disabling delivery to the gaming portion for a known piece of advertising content selected from the plurality of different pieces of advertising content based on a current value of the characteristic for the known piece of advertising content.

2. A method according to claim 1, wherein the defined characteristic for the known piece of advertising content relates to a status of an entity of the advertisement-providing portion that is associated with the known piece of advertising content.

3. A method according to claim 2, wherein a value of the characteristic is selected from a first value representative of an enabled status and a second value representative of a disabled status.

4. A method according to claim 3, wherein the entity associated with the known piece of advertising content is selected from a group consisting of: an advertising service provider (ADSP); an ad agency; an advertiser; a game publisher; and, a game console provider.

5. A method according to claim 1, wherein the defined characteristic for the known piece of advertising content relates to a status of a gaming portion-side entity.

6. A method according to claim 5, wherein the status of a gaming portion-side entity relates to one of a geographical location of the gaming portion-side entity, a current local time of the gaming portion-side entity, and a delivery accepting status of the gaming portion-side entity.

7. A method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising:
providing a piece of advertising content for being displayed by the gaming portion during game play, the piece of advertising content associated with an entity of the advertisement-providing portion;
determining a current status of the entity of the advertisement-providing portion; and,
when the current status of the entity of the advertisement-providing portion is indicative of an enabled content delivery state, making the piece of advertising content available for display by the gaming portion.

8. A method according to claim 7, comprising when the current status of the entity of the advertisement-providing portion is indicative of a not-enabled content delivery state, making the piece of advertising content unavailable for display by the video game.

9. A method according to claim 7, wherein the entity of the advertisement-providing portion is selected from a group consisting of: an advertising service provider (ADSP); an ad agency; an advertiser; a game publisher; and, a game console provider.

10. A method according to claim 7, wherein the step of determining a current status of the provider-side entity is performed by an advertising broker site of the advertisement-providing portion.

11. A method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising:
retrievably storing first data relating to an inventory of advertising content, the first data including entries for specific pieces of advertising content and accessible within the advertisement-providing portion;
retrievably storing second data relating to a rule for excluding a specific piece of advertising content from a list of advertising content that is available for display by the gaming portion, the second data accessible within the advertisement-providing portion;
receiving a request at the advertisement-providing portion for an indication of advertising content that is available for display by the gaming portion; and, accessing the stored second data, for applying the rule to determine an indication of advertising content that is available for display by the gaming portion, the indication excluding the specific piece of advertising content the rule is satisfied.

12. A method according to claim 11, wherein the second data relating to a rule for excluding a specific piece of advertising content is data relating to a current status of an entity that is associated with the specific piece of advertising content.

13. A method according to claim 12, wherein a value of the second data is selected from a first value representative of an enabled status and a second value representative of a disabled status.

14. A method according to claim 13, wherein the entity that is associated with the specific piece of advertising content is selected from a group consisting of: an advertising service provider (ADSP); an ad agency; an advertiser; a game publisher; and, a game console provider.

15. A method for automatically enabling and disabling advertising in an advertising enabled gaming environment, the environment including a gaming portion for supporting game play and for displaying advertising content during game play, and an advertisement-providing portion that is in communication with the gaming portion via a communications network, the method comprising:
providing a piece of advertising content for being displayed by the gaming portion during game play, the piece of advertising content associated with a first entity of the advertisement-providing portion;
retrievably storing data for being accessed by a second entity of the advertisement-providing portion, the data relating to a current status of the first entity;
receiving a request at the second entity for pieces of advertising content that are available for display by the gaming portion;
accessing the stored data at the second entity;
determining a current status of the first entity based on the accessed stored data; and,
excluding the piece of advertising content from a list of pieces of advertising content that are available for display by the gaming portion, in dependence upon the determining that the current status of the first entity is not-enabled for delivery of advertising content associated therewith.

16. A method comprising:
providing a video game in execution on a gaming platform having communications with a communications network;
providing a server within the communications network for delivering of advertising content to the video game, the advertising content retrievably stored in at least a storage location for access by the server; and,
selectively disabling delivery of the advertising content to the video game, absent disabling of a network connection between the gaming platform and the server and absent deleting of the advertising content from the at least a storage location.

17. A method according to claim 16, comprising delivering of other advertising content to the video game, the other advertising content retrievably stored in at least a storage location for access by the server.

18. A method according to claim 16, comprising providing an advertising broker site within the communications network, wherein selectively disabling is performed at the advertising broker site.

19. A method according to claim 16, comprising providing an advertising service provider (ADSP) within the communications network, wherein selectively disabling is performed at the ADSP.

20. A method according to claim 16, wherein the server is a server of the ADSP.

21. A method according to claim 16, wherein selectively disabling delivery of the advertising content comprises sending a response to the video game for disabling display of the advertising content that is cached locally to the video game.

22. A method according to claim 16, wherein selectively disabling comprises:
providing a first set of rules, the first set of rules including at least a rule resulting in providing the advertising content to the video game and at least a rule resulting in other than providing the advertising content to the video game; and,
determining based on available data an outcome of processing of the first set of rules to determine whether to disable delivery of advertising content in response thereto.

23. A method according to claim 16, comprising determining geographical location (geolocation) data relevant to the video game, wherein selectively disabling delivery of the advertising content to the video game is based on the determined geolocation data.

24. A method according to claim 16, comprising determining game console-type data relevant to the video game, wherein selectively disabling delivery of the advertising content to the video game is based on the determined game console-type data.

25. A method according to claim 16, comprising determining real-world local time data relevant to the video game, wherein selectively disabling delivery of the advertising content to the video game is based on the determined real-world local time data.

26. A method according to claim 16, comprising determining virtual-world local time data relevant to the video game, wherein selectively disabling delivery of the advertising content to the video game is based on the determined virtual-world local time data.

27. A method according to claim 16, comprising determining game title data relevant to the video game, wherein selectively disabling delivery of the advertising content to the video game is based on the determined game title data.

28. A method according to claim 16, comprising determining game provider data relevant to the video game, wherein selectively disabling delivery of the advertising content to the video game is based on the determined game provider data.

29. A method according to claim 16, comprising determining advertiser identity data relevant to the advertising content, wherein selectively disabling delivery of the advertising content to the video game is based on the determined advertiser identity data.

30. A method according to claim 16, comprising determining information relating to at least some of a plurality of characteristics relevant to advertising delivery, the characteristics selected from the group consisting of: a geographical location of the video game; a type of game console supporting the video game; real-world local time of the video game; a virtual-world local time of the video game; a game title of the video game; a game provider of the video game; and, identity of an advertiser that provides content for display by the video game.

31. A method according to claim 30, wherein selectively disabling delivery of the advertising content to the video game is based on information relating to at least two of the plurality of characteristics relevant to advertising delivery.

32. A method according to claim 16, comprising, when delivery of the advertising content to the video game is selectively disabled, transmitting a message to the video game to instruct same to other than display said advertising content from within the video game.

33. A method comprising:
providing a video game in execution on a gaming platform having communications with a communications network;
providing a server within the communications network for delivering of advertising content to the video game, the advertising content retrievably stored in at least a storage location for access by the server; and,
selectively enabling delivery of the advertising content to the video game, the advertising content being by default disabled for delivery to the video game.

34. A method according to claim 33, comprising providing an advertising broker site within the communications network, wherein selectively enabling is performed at the advertising broker site.

35. A method according to claim 33, comprising providing an advertising service provider (ADSP) within the communications network, wherein selectively enabling is performed at the ADSP.

36. A method according to claim 35, wherein the server is a server of the ADSP.

37. A method according to claim 33, wherein selectively enabling delivery of the advertising content comprises sending a response to the video game for enabling display of the advertising content that is cached locally to the video game.

38. A method according to claim 33, wherein selectively enabling comprises:
providing a first set of rules, the first set of rules including at least a rule resulting in providing the advertising content to the video game and at least a rule resulting in other than providing the advertising content to the video game; and,
determining based on available data an outcome of processing of the first set of rules to determine whether to enable delivery of advertising content in response thereto.

39. A method according to claim 33, comprising determining geographical location (geolocation) data relevant to the video game, wherein selectively enabling delivery of the advertising content to the video game is based on the determined geolocation data.

40. A method according to claim 33, comprising determining game console-type data relevant to the video game, wherein selectively enabling delivery of the advertising content to the video game is based on the determined game console-type data.

41. A method according to claim 33, comprising determining real-world local time data relevant to the video game, wherein selectively enabling delivery of the advertising content to the video game is based on the determined real-world local time data.

42. A method according to claim 33, comprising determining virtual-world local time data relevant to the video game, wherein selectively enabling delivery of the advertising content to the video game is based on the determined virtual-world local time data.

43. A method according to claim 33, comprising determining game title data relevant to the video game, wherein selectively enabling delivery of the advertising content to the video game is based on the determined game title data.

44. A method according to claim 33, comprising determining game provider data relevant to the video game, wherein selectively enabling delivery of the advertising content to the video game is based on the determined game provider data.

45. A method according to claim 33, comprising determining advertiser identity data relevant to the advertising content, wherein selectively enabling delivery of the advertising content to the video game is based on the determined advertiser identity data.

46. A method according to claim 33, comprising determining information relating to at least some of a plurality of characteristics relevant to advertising delivery, the characteristics selected from the group consisting of: a geographical location of the video game; a type of game console supporting the video game; real-world local time of the video game; a virtual-world local time of the video game; a game title of the video game; a game provider of the video game; and, identity of an advertiser that provides content for display by the video game.

47. A method according to claim 46, wherein selectively enabling delivery of the advertising content to the video game is based on information relating to at least two of the plurality of characteristics relevant to advertising delivery.

48. A method according to claim 33, comprising, when delivery of the advertising content to the video game is selectively enabled, transmitting a message to the video game to instruct same to display said advertising content from within the video game.

49. A method according to claim 33, comprising, when delivery of the advertising content to the video game is other than selectively enabled, transmitting a message to the video game to instruct same to other than display said advertising content from within the video game.
